(19) United States
(12) Patent Application Publication
(10) Pub. No.: US 2025/0222969 A1
(43) Pub. Date: Jul. 10, 2025

(54) Foldable Trolley

(71) Applicant: Weisha Chu, Qingdao (CN)

(72) Inventor: Weisha Chu, Qingdao (CN)

(21) Appl. No.: 19/013,117

(22) Filed: Jan. 8, 2025

(30) Foreign Application Priority Data
Jan. 8, 2024 (CN) 202420046975.7

(51) Int. Cl. B62B 3/02

(52) U.S. Cl. CPC B62B 3/025

(57) ABSTRACT

A foldable trolley, the foldable trolley comprising a trolley frame, the trolley frame comprising: a front left strut assembly, a front right strut assembly, a rear left strut assembly, a rear right strut assembly; a chassis assembly including a first chassis sub-assembly and a second chassis sub-assembly, the first chassis sub-assembly and the second chassis sub-assembly being hinged to each other such that they are pivotable about a first pivotal axis between the first and second chassis sub-assemblies, the first chassis sub-assembly being hinged to both of the front left strut assembly and the front right strut assembly to define a second pivotal axis substantially parallel to the first pivotal axis, the second chassis sub-assembly being hinged to both of the rear left strut assembly and the rear right strut assembly to define a third pivotal axis substantially parallel to the first pivotal axis.

### FIELD

The present application generally relates to a foldable trolley, especially to a retractable trolley frame of the foldable trolley.

### BACKGROUND

A foldable trolley can be used in various applications. For instance, the foldable trolley when in an unfolded state can be used to carry cargos and/or even person(s). The foldable trolley when in a folded state can occupy a smaller volume, such that the trolley itself can be conveniently stored or transported, for example placed in a motor vehicle's trunk. Therefore, main requirements for a foldable trolley, especially a household foldable trolley are that the trolley occupies a volume as small as possible in its folded state, and is as robust as possible and flexible and easy to use in its unfolded state, facilitating in carrying person(s) and/or cargos.

Moreover, a household foldable trolley, only in its unfolded state, can be used to carry cargos and/or even person(s). Therefore, in some cases, it is required for the household foldable trolley to have enough strength when it is in the unfolded state, for example to sufficiently withstand a lateral impact so as to ensure the safety of the person(s) or cargoes.

### SUMMARY

The present application is mainly aimed at proposing a novel foldable trolley which can be readily folded or unfolded by a user and can be robust in structural aspect and have a strong bearing capacity, withstanding a lateral impact when it is in an unfolded state, and which foldable trolley can be operated conveniently and flexible in application.

According to an aspect of the present application, a foldable trolley is provided, the foldable trolley having a trolley frame, the trolley frame comprising:
a front left strut assembly, a front right strut assembly, a rear left strut assembly, a rear right strut assembly;
a chassis assembly including a first chassis sub-assembly and a second chassis sub-assembly, the first chassis sub-assembly and the second chassis sub-assembly being hinged to each other such that they are pivotable about a first pivotal axis between the first and second chassis sub-assemblies, the first chassis sub-assembly being hinged to both of the front left strut assembly and the front right strut assembly to define a second pivotal axis substantially parallel to the first pivotal axis, the second chassis sub-assembly being hinged to both of the rear left strut assembly and the rear right strut assembly to define a third pivotal axis substantially parallel to the first pivotal axis;
a left side folding assembly installed between the front left strut assembly and the rear left strut assembly; and
a right side folding assembly installed between the front right strut assembly and the rear right strut assembly, wherein each of the left side folding assembly and the right side folding assembly comprises:
   a middle guide rod;
   a front intersecting rod assembly;
   a rear intersecting rod assembly; and
   a lateral support intersecting rod assembly between the front intersecting rod assembly and the rear intersecting rod assembly, the lateral support intersecting rod assembly includes a first rod and a second rod hinged thereto, a slide is provided on the middle guide rod, a hinged joint shaft between the first rod and the second rod of the lateral support intersecting rod assembly is provided on the slide.

In an embodiment, the hinged joint shaft of the lateral support intersecting rod assembly of the left side folding assembly is coaxial with the hinged joint shaft of the lateral support intersecting rod assembly of the right side folding assembly.

In an embodiment, a bottom end of the middle guide rod of the left side folding assembly is connected to a bottom end of the middle guide rod of the right side folding assembly by a connecting transverse beam.

In an embodiment, in each of the left side folding assembly and the right side folding assembly, the front intersecting rod assembly includes a longer first rod and a shorter second rod hinged thereto and the rear intersecting rod assembly includes a longer first rod and a shorter second rod hinged thereto.

In an embodiment, in each of the left side folding assembly and the right side folding assembly, the first rod of the front intersecting rod assembly is hinged to the first rod of the rear intersecting rod assembly at a top end of the middle guide rod.

In an embodiment, in each of the left side folding assembly and the right side folding assembly, both ends of the first rod of the lateral support intersecting rod assembly are hinged to the second rod of the front intersecting rod assembly and the first rod of the rear intersecting rod assembly respectively, and a hinged joint shaft between the first rod of the lateral support intersecting rod assembly and the first rod of the rear intersecting rod assembly is between the top end of the middle guide rod and a hinged joint shaft between the first rod and the second rod of the rear interesting rod assembly, the first rod of the lateral support intersecting rod assembly is hinged to the second rod of the front intersecting rod assembly at their free ends,
both ends of the second rod of the lateral support intersecting rod assembly are hinged to the first rod of the front intersecting rod assembly and the second rod of the rear intersecting rod assembly respectively, and a hinged joint shaft between the second rod of the lateral support intersecting rod assembly and the first rod of the front intersecting rod assembly is between the top end of the middle guide rod and a hinged joint shaft between the first rod and the second rod of the front intersecting rod assembly, the second rod of the lateral support intersecting rod assembly is hinged to the second rod of the rear intersecting rod assembly at their free ends.

In an embodiment, in an unfolded state of the foldable trolley, the first pivotal axis of the chassis assembly is located on or above the connection transverse beam.

In an embodiment, when the foldable trolley is switched from its unfolded state to its folded state, the slide of each middle guide rod moves from a position farthest from the connection transverse beam to a position closest to the connection transverse beam along the respective middle guide rod.

In an embodiment, when the foldable trolley is switched from the unfolded state to the folded state, the first pivotal axis between the first chassis sub-assembly and the second chassis sub-assembly moves from a position closest to the connection transverse beam to a position farthest from the connection transverse beam.

In an embodiment, the second rod of the front intersecting rod assembly of the left side folding assembly is connected to the front left strut assembly by a connection rod such that both ends of said connection rod are hinged to the second rod of the front intersecting rod assembly of the left side folding assembly and the front left strut assembly respectively;
the second rod of the rear intersecting rod assembly of the left side folding assembly is connected to the rear left strut assembly such that both ends of said connection rod are hinged to the second rod of the rear intersecting rod assembly of the left side folding assembly and the rear left strut assembly respectively;
the second rod of the front intersecting rod assembly of the right side folding assembly is connected to the front right strut assembly by a connection rod such that both ends of said connection rod are hinged to the second rod of the front intersecting rod assembly of the right side folding assembly and the front right strut assembly respectively;
the second rod of the rear intersecting rod assembly of the right side folding assembly is connected to the rear right strut assembly by a connection rod such that both ends of said connection rod are hinged to the second rod of the rear intersecting rod assembly of the right side folding assembly and the rear right strut assembly respectively.

Using the technical means described in the present application, the foldable trolley has an improved lateral impact withstanding capacity when in the unfolded state, and an improved load bearing capacity.

### BRIEF DESCRIPTION OF THE DRAWINGS

The principles and other aspects of the present application will be well understood by the following detailed description in combination with the attached drawings. It is noted that although the drawings may be given in different ratios for clarity, they do not affect understanding to the present application. In the drawings:

FIG. 1 is a perspective view schematically illustrating a foldable trolley according to an embodiment of the present application;

FIG. 2 is a perspective view schematically illustrating a trolley frame of the foldable trolley according to the embodiment of the present application;

FIG. 3 is an exploded and perspective view schematically illustrating the trolley frame of the trolley;

FIG. 4A is a side view schematically illustrating the trolley frame of the trolley in an unfolded state;

FIG. 4B is a side view schematically illustrating the trolley frame of the trolley which is being folded;

FIG. 4C is a perspective view schematically illustrating the trolley frame of the trolley which is being folded;

FIG. 4D is a perspective view schematically illustrating the trolley frame of the trolley which has been in a folded state;

FIG. 5 is a perspective view schematically illustrating a left side folding assembly and a right side folding assembly of the trolley frame of the trolley;

FIG. 6 is a perspective view schematically illustrating lateral support intersecting rod assemblies of the left and right side folding assemblies of the trolley frame of the trolley in the unfolded state; and

FIG. 7 is a perspective view schematically illustrating the lateral support intersecting rod assemblies of the left and right side folding assemblies of the trolley frame of the trolley in the folded state.

### EMBODIMENTS

In the drawings of the present application, features having the same configuration or similar functions are represented by the same reference numerals respectively.

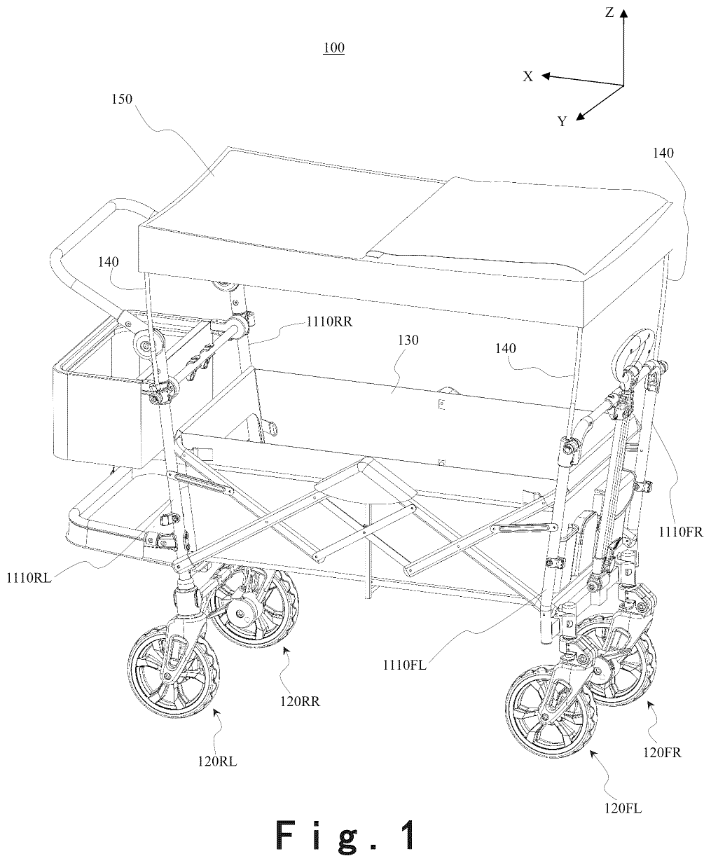

FIG. 1 schematically shows a foldable trolley 100 according to one embodiment of the present application. The foldable trolley 100 is configured to include a trolley frame 110; four wheel assemblies 120FL, 120FR, 120RL and 120RR respectively installed on a base of the trolley frame 110; a cloth assembly 130 removably attached to the trolley frame 110; four awning supporting rod assemblies 140 respectively installed at four corners of the trolley frame 110 such that they are vertical from the corners; and a shelter awning 150 detachably supported by the awning supporting rod assemblies 140.

For the sake of clarity, a Cartesian coordinate system XYZ is represented in FIG. 1 (or in some of the attached drawings), the direction of X-axis of which system is parallel or substantially parallel to a front-rear direction of the foldable trolley 100 or parallel or substantially parallel to a lengthwise direction of the trolley frame 110, the direction of Y-axis of which system is parallel or substantially parallel to a widthwise direction of the foldable trolley 100 or parallel or substantially parallel to a widthwise direction of the trolley frame 110, and the direction of Z-axis of which system is parallel or substantially parallel to a heightwise direction of the foldable trolley 100 or parallel or substantially parallel to a heightwise direction of the trolley frame 110. Furthermore, in the context of the present application, one feature being moved in a direction means that the feature being moved along the direction or parallel to the direction. The definition of the Cartesian coordinate system XYZ also applies for the other drawings of the present application. In the context of the present application, the term “front” or “rear” is only a relative directional concept, and does not mean that a direction that has to be followed by a user who is operating the foldable trolley. In fact, the terms “front” and “rear” can be swapped with each other. Similarly, the term “left” or “right” is only a relative directional concept. The terms “above” or “below” and “top” or “bottom” are relative directional concepts with respect to the direction of gravity.

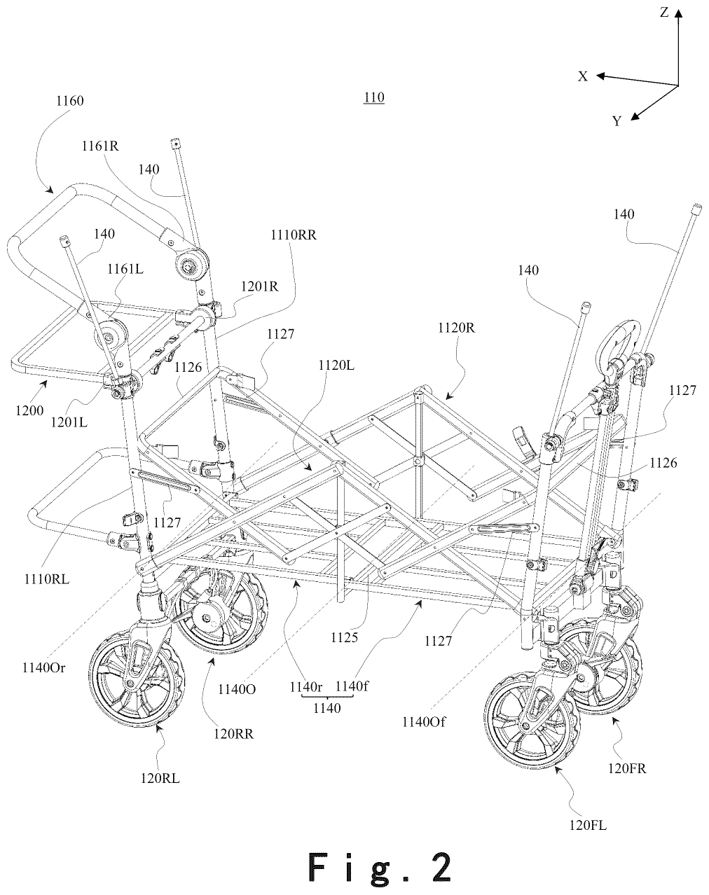

Further as shown by FIG. 2, the trolley frame 110 of the foldable trolley 100 according to the embodiment of the present application can be seen, wherein the trolley frame 110 is installed with the four wheel assemblies 120FL, 120FR, 120RL, 120RR and the four awning supporting rod assemblies 140 as shown by FIG. 1. The trolley frame 110 is configured to mainly include four strut assemblies 1110FL, 1110FR, 1110RL, 1110RR; and two side folding assemblies 1120L, 1120R, which side folding assemblies are connected to the four strut assemblies 1110FL, 1110FR, 1110RL, 1110RR respectively. The trolley frame 110 is also configured to include the chassis assembly 1140 connected at bottom ends of the four strut assemblies 1110FL, 1110FR, 1110RL, 1110RR and cooperating with the two side folding assemblies 1120L, 1120R respectively.

In the context of the present application, the symbol “F” in a reference numeral may refer to a “front” feature; the symbol “R” in a reference numeral may refer to a “rear” or “right” feature; and the symbol “L” in a reference numeral may refer to a “left” feature. For example, the reference numeral “1110FL” refers to the front left strut assembly of the trolley frame 110; and the reference numeral “1110FR” refers to the front right strut assembly of the trolley frame 110.

As shown, the four strut assemblies 110FL, 110FR, 1110RL, 1110RR are installed in such a way that they substantially stand upright with respect to the ground. The left side folding assembly 1120L is installed between the two strut assemblies 1110FL, 1110RL; and the right side folding assembly 1120R is installed between the two strut assemblies 1110FR, 1110RR. The four wheel assemblies 120FL, 120FR, 120RL, 120RR are installed at the respective bottom ends of the strut assemblies 1110FL, 1110FR, 1110RL, 1110RR respectively.

Each of the strut assemblies 1110FL, 1110FR, 1110RL, 1110RR is mainly a strut piece assembly. In the context of the present application, as required, the strut piece can be understood as a solid strut/rod piece or a hollow strut/rod piece, for example a tube. In a preferred embodiment, the tube mentioned here can be a light metal tube such as an aluminum tube or a thin-walled stainless steel tube or the like. In a preferred embodiment, each strut assembly can be configured to be telescopic.

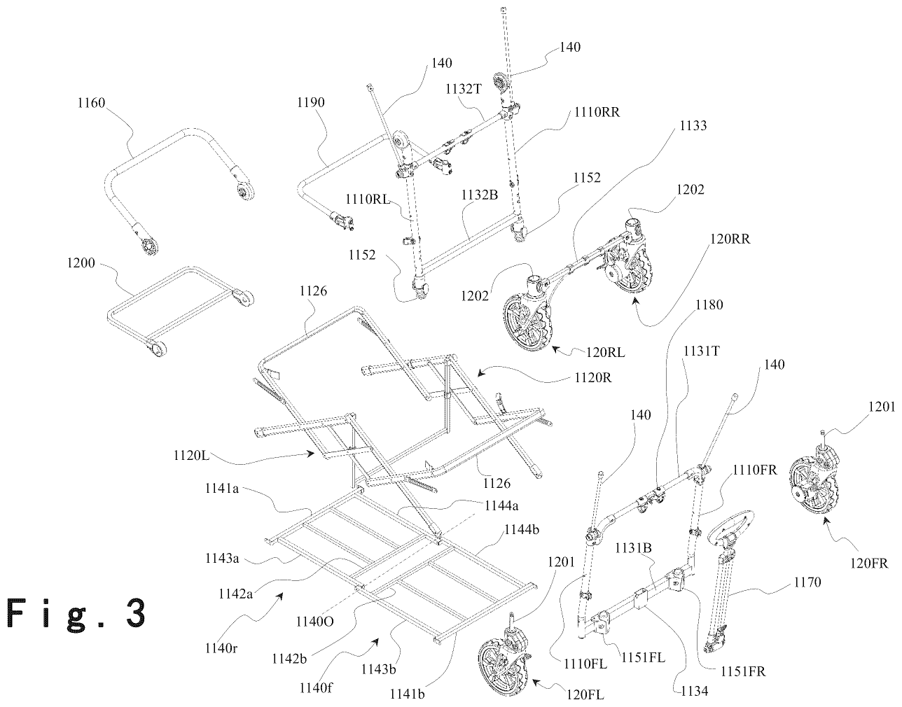

As shown by FIG. 3, the two strut assemblies 1110FL and 1110FR are connected to each other by an upper connection beam 1131T at respective upper ends of the two strut assemblies 1110FL and 1110FR, while the respective awning supporting rod assemblies 140 extend substantially vertically from the upper ends respectively. The two strut assemblies 1110FL and 1110FR are connected to each other by a lower connection beam 1131B at respective lower ends of the two strut assemblies 1110FL and 1110FR. Wheel seats 1151FL and 1151FR are securely provided on the lower connection beam 1131B respectively adjacent to the lower ends of the two strut assemblies 1110FL and 1110FR respectively. Each of the wheel seats 1151FL and 1151FR is formed with a vertical hole (invisible in the drawing) to receive a corresponding vertical pin 1201 of the respective wheel assembly 120FL or 120FR such that wheels of the wheel assemblies can roll, when they contact the ground, and can also rotate relative to the wheel seats about respective vertical axes defined by the respective vertical pins 1201.

Still as shown by FIG. 3, the two strut assemblies 1110RL and 1110RR are connected to each other by an upper connection beam 1132T at respective upper ends of the two strut assemblies 1110RL and 1110RR, while the respective awning supporting rod assemblies 140 extend substantially vertically from the upper ends respectively (for example from accessories disposed on the upper ends). The two strut assemblies 1110RL and 1110RR are connected to each other by a lower connection beam 1132B at respective lower ends of the two strut assemblies 1110RL and 1110RR. Each of the two strut assemblies 1110RL and 1110RR is provided with a connection member 1152 adjacent to the lower end thereof for connection to a respective receiving socket 1202 of the wheel assemblies 120RL, 120RR respectively. In an embodiment of the present application, the wheel assemblies 120RL, 120RR can be connected to each other by an auxiliary transverse beam 1133.

The chassis assembly 1140 is configured to include a first chassis sub-assembly 1140r and a second chassis sub-assembly 1140f which are hingedly coupled to each other. Moreover, the first chassis sub-assembly 1140r is hingedly coupled to the strut assemblies 1110FL, 1110FR, and the second chassis sub-assembly 1140b is hingedly coupled to the strut assemblies 1110RL, 1110RR. Additionally, the chassis assembly 1140 is configured to cooperate with the side folding assemblies 1120L, 11220R. For example, one of the side folding assemblies 1120L, 1120R and a respective one of the strut assemblies can define a hinged joint axis therebetween, which can coincide with a hinged joint axis defined between the chassis assembly 1140 and the respective strut assembly.

The first chassis sub-assembly 1140f is hinged to the second chassis sub-assembly 1140r such that a pivotal axis 11400 can be defined therebetween, about which pivotal axis 11400 the first chassis sub-assembly 1140f can be pivoted relative to the second chassis sub-assembly 1140r. Furthermore, the first chassis sub-assembly 1140f is hinged to and between the strut assemblies 1110FL, 1110FR such that a pivotal axis 1140Of can be defined therebetween, about which pivotal axis 1140Of the first chassis sub-assembly 1140f can be pivoted relative to the strut assemblies 1110FL, 1110FR. Furthermore, the second chassis sub-assembly 1140r is hinged to and between the strut assemblies 1110RL, 1110RR such that a pivotal axis 1140Or can be defined therebetween, about which pivotal axis 1140Or the second chassis sub-assembly 1140r can be pivoted relative to the strut assemblies 1110RL, 1110RR. When the trolley frame 110 is in an unfolded state (as shown by FIG. 2), the pivotal axes 1140O, 1140Of, 1140Or can be substantially parallel 30 to each other and to the plane XY. Therefore, the pivotal axes 1140Of, 1140Or can be regarded as the hinged joint axes between the side folding assemblies 1120L, 1120R and the respective strut assemblies.

The first chassis sub-assembly 1140f is configured to include a first rod piece 1141a and a second rod piece 1142a substantially parallel to the first rod piece 1141a. Furthermore, the first chassis sub-assembly 1140a is also configured to include several rod pieces (four being shown) perpendicularly connected to both of the first rod piece 1141a and the second rod piece 1142a, two outer rod pieces 1143a, 1144a of which rod pieces are configured to extend beyond the second rod piece 1142a.

The second chassis sub-assembly 1140r is configured to include a first rod piece 1141b and a second rod piece 1142b substantially parallel to the first rod piece 1141b. Furthermore, the second chassis sub-assembly 1140r is also configured to include several rod pieces (four being shown) perpendicularly connected to both of the first rod piece 1141b and the second rod piece 1142b, two outer rod pieces 1143b, 1144b of which rod pieces are configured to extend beyond the second rod piece 1142b. The rod pieces 1143a and 1143b are hinged to the rod pieces 1144a and 1144b respectively such that the pivotal axis 11400 are defined therebetween. Additionally, the first rod piece 1141a is hinged to the strut assemblies 1110FL, 1110FR respectively to define the pivotal axis 1140Of, and the first rod piece 1141b is hinged to the strut assemblies 1110RL, 1110RR respectively to define the pivotal axis 1140Or.

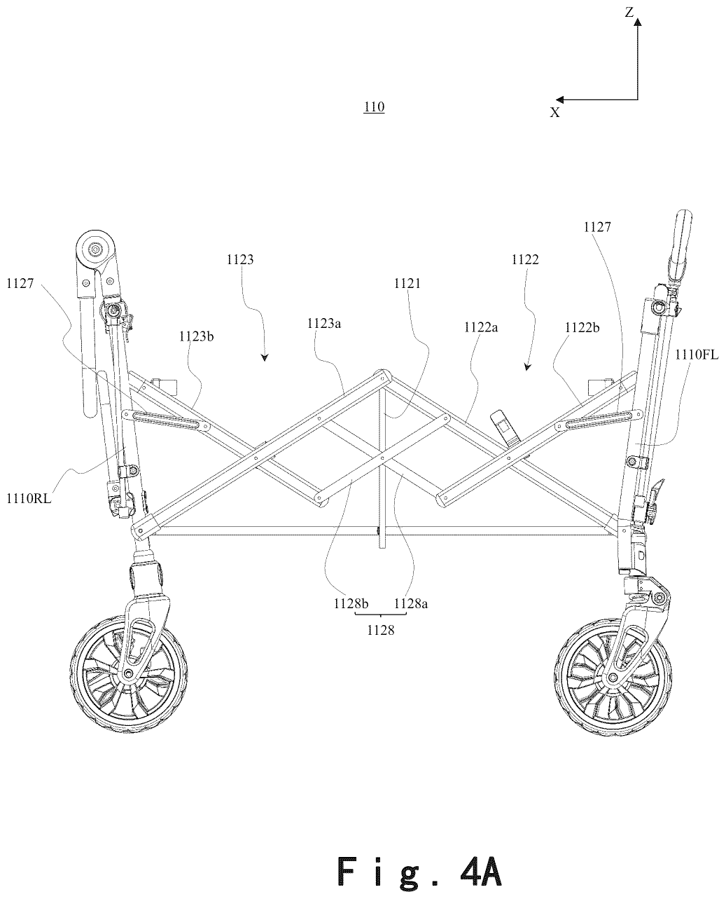

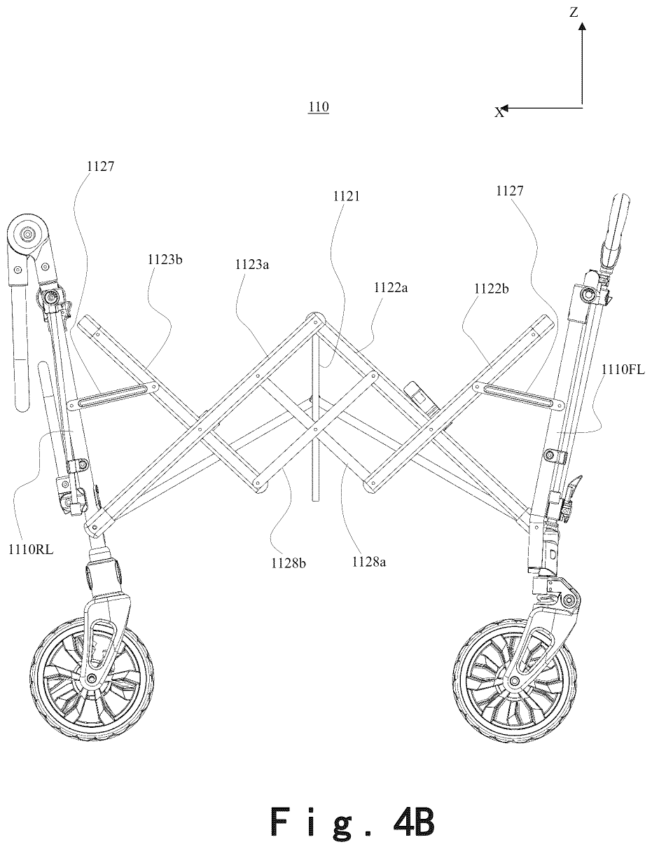

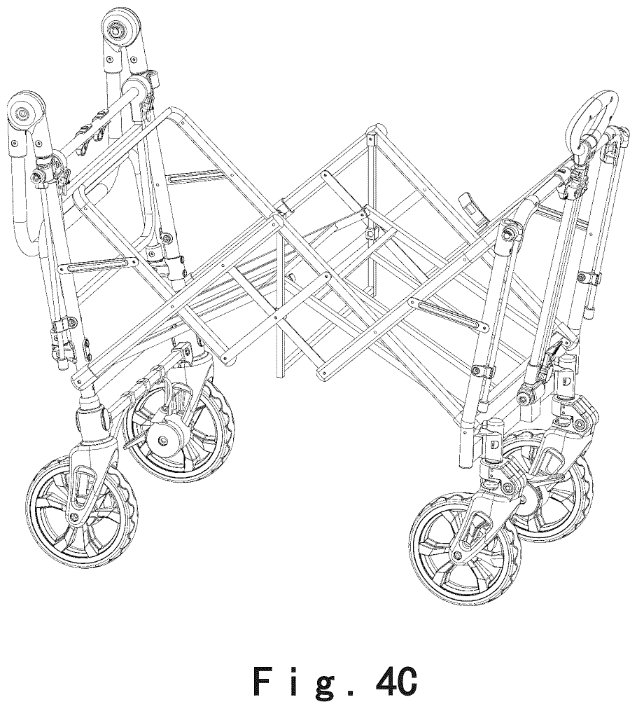

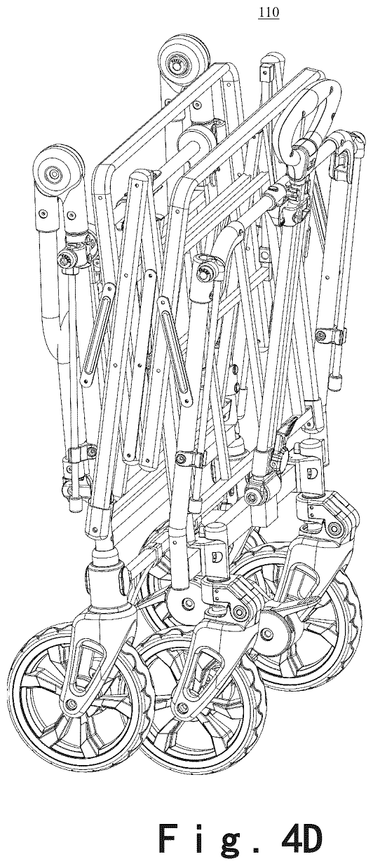

When the trolley frame 110 is switched from the unfolded state as shown by FIG. 4A to a folded state as shown by FIG. 4B, the pivotal axes 1140Of, 1140Or move towards each other to approach each other while the pivotal axis 11400 gradually moves away from the ground or a plane where the pivotal axes 1140Of, 1140Or locate. When the trolley frame 110 is finally in the folded state (as shown by FIG. 4D), the pivotal axis 11400 arrives at a position farthest from the ground or the plane where the pivotal axes 1140Of, 1140Or locate.

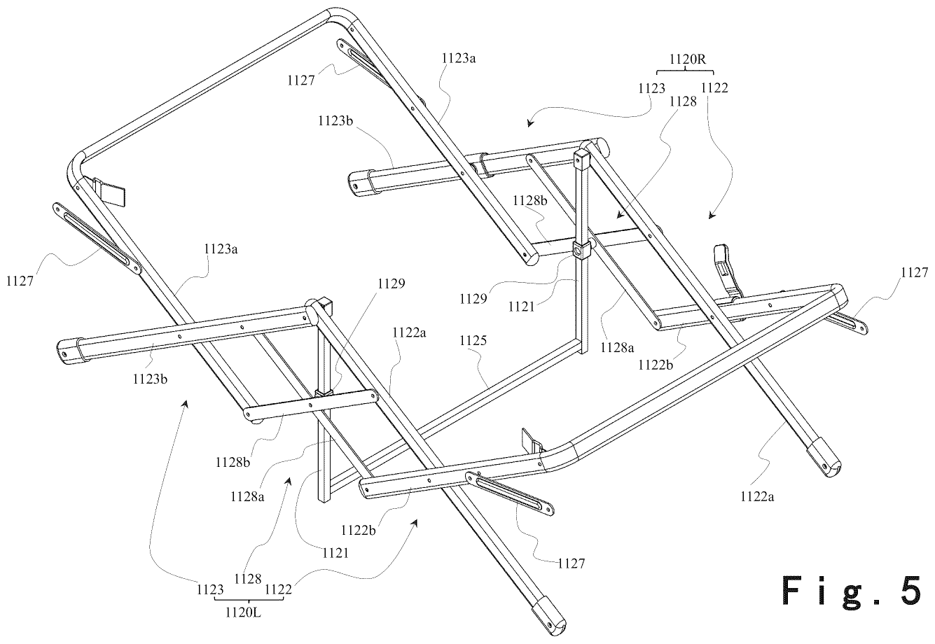

The left and/or right side folding assembly 1120L and/or 1120R is configured to include a middle guide rod 1121, a front intersecting rod assembly 1122, and a rear intersecting rod assembly 1123. As shown by FIG. 5, a bottom end of the middle guide rod 1121 of the left right side folding assembly 1120L and a bottom end of a middle guide rod 1121 of the right side folding assembly 1120R are connected to each other by a connection transverse beam 1125.

The front intersecting rod assembly 1122 is configured to include a longer first rod 1122a and a shorter second rod 1122b hinged to each other. The rear intersecting rod assembly 1123 is configured to include a longer first rod 1123a and a shorter second rod 1123b hinged to each other. The longer first rods 1122a and 1123a are hinged to each other at a top end of the middle guide rod 1121, while an opposing end of the longer first rod 1122a is hinged to the strut assembly 1110FL to define a pivotal axis which can be substantially parallel with or substantially coincide with the pivotal axis 1140Of; and an opposing end of the longer rod 1123a is hinged to the strut assembly 1110FR to define a pivotal axis which can be substantially parallel with or substantially coincide with the pivotal axis 1140Or. The shorter second rods 1122b, 1123b themselves can be configured to be not directly hinged to any strut assembly. Furthermore, the shorter second rod 1122b of the left side folding assembly 1120L and the shorter second rod 1122b of the right side folding assembly 1120R are connected to each other at their free ends by a connection transverse beam 1126. Similarly, the shorter second rod 1123b of the left side folding assembly 1120L and the shorter second rod 1123b of the right side folding assembly 1120R are connected to each other at their free ends by a connection transverse beam 1126.

The second rod 1122b of the left side folding assembly 1120L is hinged to an end of a connection rod 1127 adjacent to the connection transverse beam 1126, while an opposing end of the connection rod 1127 is hinged to the strut assembly 1110FL. Similarly, the second rod 1122b of the right side folding assembly 1120R is hinged to an end of a connection rod 1127 adjacent to the connection beam 1126, while an opposing end of the connection rod 1127 is hinged to the strut assembly 1110FR. Therefore, a hinged joint axis between the second rod 1122b of the left side folding assembly 1120L and the associated connection rod 1127 is coaxial with a hinged joint axis between the second rod 1122b of the right side folding assembly 1120R and the associated connection rod 1127, and a hinged joint axis between the associated connection rod 1127 and the respective strut assembly 1110FL is also coaxial with a hinged joint axis between the associated connection rod 1127 and the respective strut assembly 1110FR.

The second rod 1123b of the left side folding assembly 1120L is hinged to an end of a connection rod 1127 adjacent to the connection transverse beam 1126, while an opposing end of the connection rod 1127 is hinged to the strut assembly 1110RL. Similarly, the second rod 1123b of the right side folding assembly 1120R is hinged to an end of a connection rod 1127 adjacent to the connection transverse beam 1126, while an opposing end of the connection rod 1127 is hinged to the strut assembly 1110RR adjacent to the connection transverse beam 1126. Therefore, a hinged joint axis between the second rod 1123b of the left side folding assembly 1120L and the associated connection rod 1127 is coaxial with a hinged joint axis between the second rod 1123b of the right side folding assembly 1120R and the associated connection rod 1127, and a hinged joint axis between the associated connection rod 1127 and the respective strut assembly 1110RL is also coaxial with a hinged joint axis between the associated connection rod 1127 and the respective strut assembly 1110RR.

The chassis assembly 1140 is configured such that when the trolley frame 1110 is in its unfolded state, the chassis assembly 1140 can be located on or above the connection transverse beam 1125, for example the pivotal axis 11400 of the chassis assembly 1140 can be located on or above the connection transverse beam 1125. In this way, when the trolley frame 110 is in its unfolded state, the connection transverse beam 1125 can be used to support the chassis assembly 1140, resulting in an improved load bearing capacity of the chassis assembly 1140.

In an embodiment of the present application, each of the left side folding assembly 1120L and the right side folding assembly 1120R is also configured to include a lateral support intersecting rod assembly 1128 between the front intersecting rod assembly 1122 and the rear intersecting rod assembly 1123. As shown, each lateral support intersecting rod assembly 1128 is configured to include a first rod 1128a and a second rod 1128b hinged to the first rod.

A slide 1129 is provided on each middle guide rod 1121. For example, the slide 1129 can be in the form of a short tube which is sleeved on the middle guide rod 1121 such that it is freely slidable back and forth along a lengthwise direction of the middle guide rod 1121. A hinged joint point (or a hinged joint axis) between the first rod 1128a and the second rod 1128b of each lateral support intersecting rod assembly 1128 is disposed on the slide 1129 such that the hinged joint axes of the two lateral support intersecting rod assemblies 1128 are coaxial with each other. One rod of each lateral support intersecting rod assembly 1128 at its both ends is hinged to one longer rod of the front intersecting rod assembly 1122 and one shorter rod of the rear intersecting rod assembly 1123 of the respective side folding assembly 1120L or 1120R respectively, and the other rod of each lateral support intersecting rod assembly 1128 at its both ends is hinged to the other shorter rod of the front intersecting rod assembly 1122 and the other longer rod of the rear intersecting rod assembly 1123 of the respective side folding assembly 1120L or 1120R respectively.

For instance, in the illustrated embodiment, take the left side folding assembly 1120L for example, the first rod 1128a of the lateral support intersecting rod assembly 1128 at its both ends is hinged to the shorter second rod 1122b of the front intersecting rod assembly 1122 and the longer first rod 1123a of the rear intersecting rod assembly 1123 respectively, and a hinged joint point between the first rod 1128a and the first rod 1123a is located between a hinged joint point between the first rod 1123a and the middle guide rod 1121 and a hinged joint point between the first rod 1123a and the second rod 1123b, a hinged joint point between the first rod 1128a and the second rod 1122b is located at free ends of the two rods. The second rod 1128b of the lateral support intersecting rod assembly 1128 at it both ends is hinged to the longer first rod 1122a of the front intersecting rod assembly 1122 and the shorter second rod 1123b of the rear intersecting rod assembly 1123 respectively, and a hinged joint point between the second rod 1128b and the first rod 1122a is located between a hinged joint point between the first rod 1122a and the middle guide rod 1121 and a hinged joint point between the first rod 1122a and the second rod 1122b. A hinged joint point between the second rod 1128b and the second rod 1132b is at free ends of the two rods.

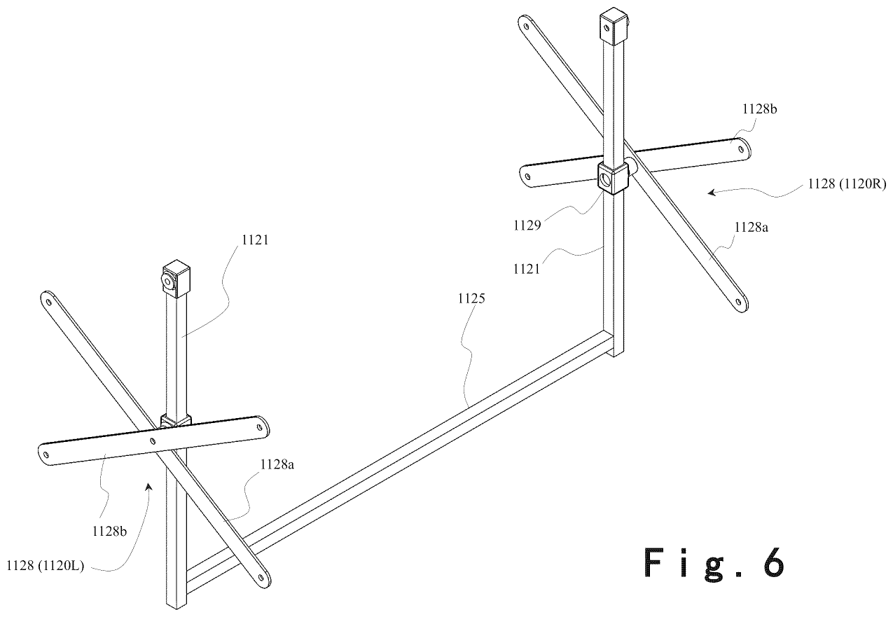

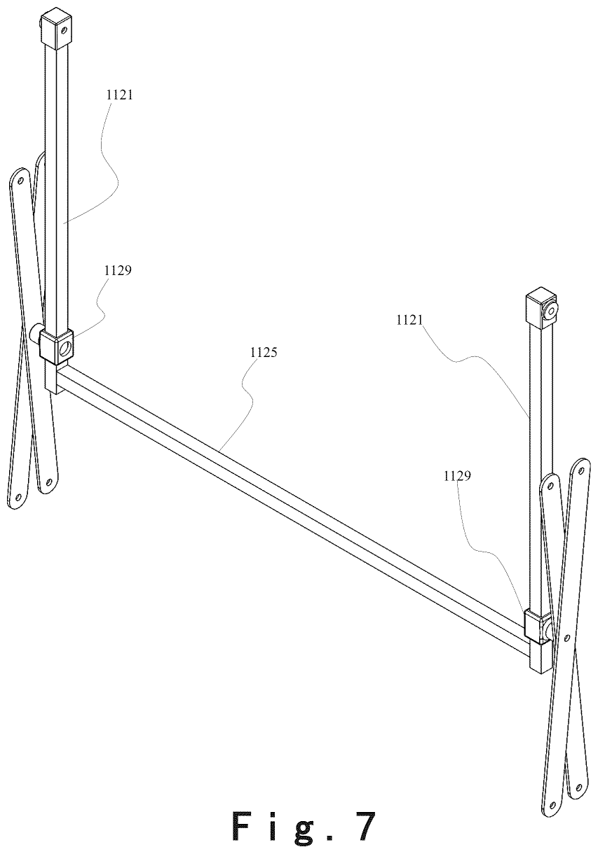

The left side folding assembly 1120L and the right side folding assembly 1120R are configured such that as the trolley frame 1110 is switched from the unfolded state (as shown by FIG. 4A) to the folded state (as shown by FIG. 4D), the slide 1129 of each middle guide rod 1121 moves from a position (as shown by FIG. 6) farthest from the connection transverse beam 1125 to a position (as shown by FIG. 7) closest to the connection transverse beam 1125. When the trolley frame 110 is in the unfolded state, the existence of the respective lateral support intersecting rod assemblies 1128 of the left and right side folding assemblies enables the left side folding assembly 1120L and the right side folding assembly 1120R to sufficiently withstand a lateral impact load, resulting in an improved durability of the trolley. Furthermore, the chassis assembly 1140 is configured such that as the trolley frame 110 is switched from the unfolded state (as shown by FIG. 4A) to the folded state (as shown by FIG. 4D), the pivotal axis 11400 between the first chassis sub-assembly 1140F and the second chassis sub-assembly 1140r moves from a position (as shown by FIG. 2) closest to the connection transverse beam 1125 to a position (as shown by FIG. 4D) farthest from the connection transverse beam 1125.

In the illustrated embodiment, the hinged joint point (or a hinged joint shaft) of each lateral support intersecting rod assembly 1128 is located laterally outside the respective middle guide rod 1121. In an alternative embodiment, the hinged joint point (or the hinged joint shaft) of each lateral support intersecting rod assembly 1128 can be located laterally inside the respective middle guide rod 1121 such that when suffering from a lateral impact load, the middle guide rod 1121 together with the respective lateral support interesting rod assembly 1128 can withstand the lateral impact load, resulting in an improved durability and firmness of the trolley.

Further as shown by FIG. 3, a carrier 1134 is provided on the lower connection beam 1131B between the two strut assemblies 1110FL and 1110FR. The carrier is configured to be pivotally connected to a pull rod assembly 1170. For instance, a lower end of the pull rod assembly 1170 is pivotably connectable to the carrier 1134 such that the pull rod assembly 1170 is pivotable about an axis substantially parallel to the axis Y. An opposing end of the pull rod assembly 1170 is designed such that it can be grasped by a hand of a user and thus the foldable trolley 100 or the trolley frame 110 can be pulled. Furthermore, a holder 1180 is provided on the upper connection beam 1131T between the two strut assemblies 1110FL and 1110FR to selectively hold the pull rod assembly 1170, such that the pull rod assembly 1170 can be selectively engaged by the holder 1180 to be kept securely relative to the trolley frame 110.

As shown by FIG. 2, a handle grip assembly 1160 is configured to include a left connection joint 1161L, a right connection joint 1161R, and linkage rods connected respectively between the joints. In the context of the present application, the term “connection joint” means that due to the existence of the connection joint, two features connected/coupled by the connection joint are rotatable relative to each other about a rotational axis defined by the connection joint. Therefore, the left connection joint 1161L and the right connection joint 1161R of the handle grip assembly 1160 can be connected to respective top ends of the rear left strut assembly 1110RL and of the rear right strut assembly 1110RR, for example fastened thereto via suitable fasteners such as screws. After being connected in place, rotational axes of the left connection joint 1161L and the right connection joint 1161R are substantially coaxial with each other and are substantially parallel to the pivotal axis 1140Or. It should be understood by a person skilled in the art that rotational positions of the connection joints themselves can be relative fixed. That is to say, after the handle grip assembly 1160 is installed in place, it can be rotated to a suitable position relative to the strut assemblies as required and locked there. Then, as desired, it can be unlocked and rotated again.

As shown by FIG. 2, the trolley frame 110 is additionally configured to include an auxiliary extensible bracket 1190. This auxiliary extensible bracket 1190 can be configured in a manner similar to the handle grip assembly 1160. That is, the auxiliary extensible bracket 1190 can be comprised of a plurality of rod pieces. The auxiliary extensible bracket 1190 at its both ends can be hingedly coupled to the strut assemblies 1110RL, 1110RR respectively. In this way, when the trolley frame 1110 is in the unfolded state, the auxiliary extensible bracket 1190 is pivotable relative to the strut assemblies 1110RL, 1110RR. Therefore, when a person is in the trolley frame 110 in its unfolded state, the auxiliary extensible bracket 1190 can be selectively pivoted into a substantially horizontal position at which legs of the person can be readily supported by the bracket 1190, enabling the person in the trolley frame to feel more comfortable.

Similarly, the trolley frame 110 is also configured to include an auxiliary bracket 1200. The auxiliary bracket is configured to include a left connection joint 1201L, a right connection joint 1201R, and linkage rods connected respectively between the joints. The left connection joint 1201L and the right connection joint 1201R can be configured in a way similar to the left connection joint 1161L and the right connection joint 1161R respectively, such that the left connection joint 1201L and the right connection joint 1201R can be connected to the rear left strut assembly 1110RL and the rear right strut assembly 1110RR below the left connection joint 1161L and the right connection joint 1161R respectively, for example fastened thereto via suitable fasteners such as screws. After being connected in place, rotational axes of the left connection joint 1201L and the right connection joint 1201R are substantially coaxial with each other and are substantially parallel to the pivotal axis 1140Or. It should be understood by a person skilled in the art that rotational positions of the connection joints themselves can be relative fixed. That is to say, after the auxiliary bracket 1200 is installed in place, it can be rotated to a suitable position relative to the strut assemblies as required and locked there. Then, as desired, it can be unlocked and rotated again.

The cloth assembly 130 may be comprised of several awning sheets. For example, Velcro fasteners can be provided in the cloth assembly at desire locations such that the cloth assembly can be readily attached to the respective rod pieces of the assemblies. For instance, after the trolley frame 110 is assembled in place, the cloth assembly 130 can be attached to the respective assemblies as already mentioned so as to constitute the foldable trolley 100 as shown by FIG. 1. When it is required to be folded for storage, the trolley 10 frame 110 according to the present application can be transferred from the unfolded state as shown by FIG. 4A, through a state as shown by FIGS. 4B and 4C, finally into the folded state as shown by FIG. 4D. During the transferring process, the assemblies will be folded and be moved relatively towards each other in the direction of X so as to ensure that the trolley frame 110 in its folded state will occupy a minimized volume. Furthermore, in the unfolded state, the specific design of the assemblies constituting the trolley frame 110 will enable the entire trolley frame to be more robust.

Although some specific embodiments of the present application are described in details here, they are given for illustrative purposes only and cannot be deemed to constrain the scope of the present application in any way. Furthermore, it should be understood by the ordinary person in the art that the embodiments described here can be arbitrarily combined with each other. Without departing from the spirit and scope of the present application, various alternations, replacements and modifications can be thought out.

1. A foldable trolley, the foldable trolley having a trolley frame, the trolley frame comprising:
a front left strut assembly, a front right strut assembly, a rear left strut assembly, a rear right strut assembly;
a chassis assembly including a first chassis sub-assembly and a second chassis sub-assembly, the first chassis sub-assembly and the second chassis sub-assembly being hinged to each other such that they are pivotable about a first pivotal axis between the first and second chassis sub-assemblies, the first chassis sub-assembly being hinged to both of the front left strut assembly and the front right strut assembly to define a second pivotal axis substantially parallel to the first pivotal axis, the second chassis sub-assembly being hinged to both of the rear left strut assembly and the rear right strut assembly to define a third pivotal axis substantially parallel to the first pivotal axis;
a left side folding assembly installed between the front left strut assembly and the rear left strut assembly; and
a right side folding assembly installed between the front right strut assembly and the rear right strut assembly, wherein each of the left side folding assembly and the right side folding assembly comprises:
a middle guide rod;
a front intersecting rod assembly;
a rear intersecting rod assembly; and
a lateral support intersecting rod assembly between the front intersecting rod assembly and the rear intersecting rod assembly, the lateral support intersecting rod assembly includes a first rod and a second rod hinged thereto, a slide is provided on the middle guide rod, a hinged joint shaft between the first rod and the second rod of the lateral support intersecting rod assembly is provided on the slide.

2. The foldable trolley of claim 1, wherein the hinged joint shaft of the lateral support intersecting rod assembly of the left side folding assembly is coaxial with the hinged joint shaft of the lateral support intersecting rod assembly of the right side folding assembly.

3. The foldable trolley of claim 2, wherein a bottom end of the middle guide rod of the left side folding assembly is connected to a bottom end of the middle guide rod of the right side folding assembly by a connecting transverse beam.

4. The foldable trolley of claim 3, wherein in each of the left side folding assembly and the right side folding assembly, the front intersecting rod assembly includes a longer first rod and a shorter second rod hinged thereto and the rear intersecting rod assembly includes a longer first rod and a shorter second rod hinged thereto.

5. The foldable trolley of claim 4, wherein in each of the left side folding assembly and the right side folding assembly, the first rod of the front intersecting rod assembly is hinged to the first rod of the rear intersecting rod assembly at a top end of the middle guide rod.

6. The foldable trolley of claim 5, wherein in each of the left side folding assembly and the right side folding assembly, both ends of the first rod of the lateral support intersecting rod assembly are hinged to the second rod of the front intersecting rod assembly and the first rod of the rear intersecting rod assembly respectively, and a hinged joint shaft between the first rod of the lateral support intersecting rod assembly and the first rod of the rear intersecting rod assembly is between the top end of the middle guide rod and a hinged joint shaft between the first rod and the second rod of the rear interesting rod assembly, the first rod of the lateral support intersecting rod assembly is hinged to the second rod of the front intersecting rod assembly at their free ends,
both ends of the second rod of the lateral support intersecting rod assembly are hinged to the first rod of the front intersecting rod assembly and the second rod of the rear intersecting rod assembly respectively, and a hinged joint shaft between the second rod of the lateral support intersecting rod assembly and the first rod of the front intersecting rod assembly is between the top end of the middle guide rod and a hinged joint shaft between the first rod and the second rod of the front intersecting rod assembly, the second rod of the lateral support intersecting rod assembly is hinged to the second rod of the rear intersecting rod assembly at their free ends.

7. The foldable trolley of claim 6, wherein in an unfolded state of the foldable trolley, the first pivotal axis of the chassis assembly is located on or above the connection transverse beam.

8. The foldable trolley of claim 7, wherein when the foldable trolley is switched from its unfolded state to its folded state, the slide of each middle guide rod moves from a position farthest from the connection transverse beam to a position closest to the connection transverse beam along the respective middle guide rod.

9. The foldable trolley of claim 8, wherein when the foldable trolley is switched from the unfolded state to the folded state, the first pivotal axis between the first chassis sub-assembly and the second chassis sub-assembly moves from a position closest to the connection transverse beam to a position farthest from the connection transverse beam.

10. The foldable trolley of claim 9, wherein the second rod of the front intersecting rod assembly of the left side folding assembly is connected to the front left strut assembly by a connection rod such that both ends of said connection rod are hinged to the second rod of the front intersecting rod assembly of the left side folding assembly and the front left strut assembly respectively;
the second rod of the rear intersecting rod assembly of the left side folding assembly is connected to the rear left strut assembly such that both ends of said connection rod are hinged to the second rod of the rear intersecting rod assembly of the left side folding assembly and the rear left strut assembly respectively;
the second rod of the front intersecting rod assembly of the right side folding assembly is connected to the front right strut assembly by a connection rod such that both ends of said connection rod are hinged to the second rod of the front intersecting rod assembly of the right side folding assembly and the front right strut assembly respectively;
the second rod of the rear intersecting rod assembly of the right side folding assembly is connected to the rear right strut assembly by a connection rod such that both ends of said connection rod are hinged to the second rod of the rear intersecting rod assembly of the right side folding assembly and the rear right strut assembly respectively.
